(19) United States
(12) Patent Application Publication
(10) Pub. No.: US 2019/0291517 A1
(43) Pub. Date: Sep. 26, 2019

(54) TYRE

(71) Applicant: SUMITOMO RUBBER INDUSTRIES, LTD., Hyogo (JP)

(72) Inventor: Koichi NAKAJIMA, Hyogo (JP)

(73) Assignee: SUMITOMO RUBBER INDUSTRIES, LTD., Hyogo (JP)

(21) Appl. No.: 16/292,686

(22) Filed: Mar. 5, 2019

(30) Foreign Application Priority Data
Mar. 26, 2018 (JP) 2018-058490

(51) Int. Cl. B60C 13/00; B60C 13/02

(52) U.S. Cl. CPC B60C 13/001; B60C 13/02

(57) ABSTRACT

A mark indicating portion arranged on a sidewall portion is provided with a reference surface provided on a surface of the sidewall portion and one or more marks formed on the reference surface in a concave manner. A surface of the or each mark is divided into a first surface portion and a second surface portion by a section line. Each of the first surface portion and the second surface portion is inclined in a direction in which a depth thereof from the reference surface is decreased as it goes away from the section line.

### TECHNICAL FIELD

The present invention relates to a tyre having improved legibility of a concave mark.

### BACKGROUND ART

On a surface of at least one of the sidewall portions of the tyre, one or more marks which are letters, symbols, and the like indicating the manufacturer name, brand name, size, and the like of the tyre are formed. In order to improve the legibility of the marks, they are usually formed in a convex shape which is one step higher than the surface of the sidewall portion.

### SUMMARY OF THE INVENTION

However, convex marks have a problem of large air resistance.

Therefore, in recent year's, there has been a demand that the marks are formed in a concave shape recessed from the surface of the sidewall portion. However, the concave marks are formed to be shallow, therefore, they have poor legibility than the convex marks. Further, in a tyre meridian section, the surface of the sidewall portion is convexly curved. Thereby, when bottom surfaces of the marks are flat, depending on the placement position, the bottom surfaces face downward or upward, therefore, the legibility tends to be further deteriorated.

Note that Japanese Unexamined Patent Publication No. 2013-129233 has proposed improving legibility by disposing rubber having a different color on inner surfaces of the concave marks. However, the use of the rubber having the different color causes an increase in the types of rubber and an increase in the number of process by attaching the rubber, therefore, it is possible that the cost is increased.

An object of the present invention is to provide a tyre capable of improving the legibility of concave marks without using rubber having a different color and the like.

In one aspect of the present invention, a tyre comprises a sidewall portion provided with a mark indicating portion having one or more marks, wherein the mark indicating portion comprises a reference surface provided on a surface of the sidewall portion and the one or more marks formed on the reference surface in a concave manner, a surface of the or each mark is divided into a first surface portion and a second surface portion by a section line crossing the surface of the or each mark, and each of the first surface portion and the second surface portion is inclined in a direction in which a depth thereof from the reference surface is decreased as it goes away from the section line.

In another aspect of the invention, it is preferred that the section line extends on the surface of the or each mark in a tyre circumferential direction or diagonally.

In another aspect of the invention, it is preferred that a depth of the section line from the reference surface is constant.

In another aspect of the invention, it is preferred that the section line is a straight line or an arcuate curved line.

In another aspect of the invention, it is preferred that each of the first surface portion and the second surface portion is a flat surface or a concave or convex curved surface.

In another aspect of the invention, it is preferred that the mark indicating portion is provided with a base portion projecting from the surface of the sidewall portion at a constant height, and a surface of the base portion forms the reference surface.

Further, when the section line extends diagonally, for example, the first surface portion and the second surface portion are inclined in opposite directions with respect to both a tyre radial direction and the tyre circumferential direction. Thereby, it is possible that effects of both cases where the section line extends in the tyre circumferential direction and where the section line extends in the tyre radial direction are exerted, therefore, it is possible that the legibility is further improved.

### BRIEF DESCRIPTION OF THE DRAWINGS

FIG. 1 is a partial perspective view of a tyre according to an embodiment of the present invention.

FIG. 2 is an enlarged partial perspective view of marks.

FIG. 3A is a front view of one of the marks.

FIG. 3B is a cross-sectional view of the one of the marks taken along A-A line of FIG. 3A.

FIG. 4A is a front view of one of the marks according to another embodiment.

FIG. 4B a cross-sectional view of the one of the marks according to another embodiment taken along B-B line of FIG. 4A.

FIG. 5A is a diagram illustrating a diagonal line.

FIG. 5B is a diagram illustrating a diagonal line.

### DESCRIPTION OF THE PREFERRED EMBODIMENT

An embodiment of the present invention will now be described below in detail.

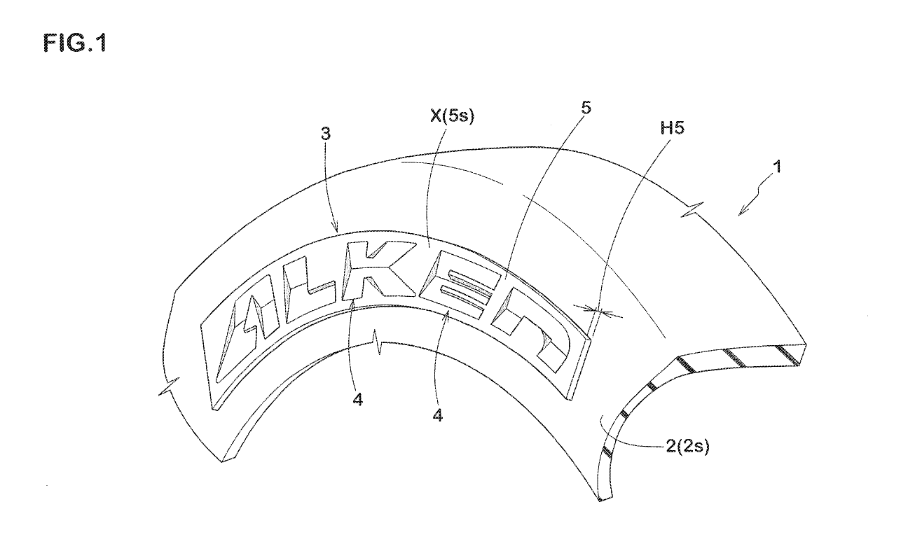

As shown in FIG. 1, a tyre 1 in this embodiment is provided with one or more mark indicating portions 3 in at least one of sidewall portions 2.

Each of the mark indicating portions 3 is provided with a reference surface (x) provided on a surface (2s) of respective one of the sidewall portions 2 and one or more marks 4 formed on the reference surface (x) in a concave manner. In this embodiment, each of the mark indicating portions 3 is provided with a base portion 5 which projects stepwise from the surface (2s) of a respective one of the sidewall portions 2 at a constant height (115) (that is, a top surface of the base portion is not inclined with respect to the surface (2s)) and a surface (5s) of the base portion 5 forms the reference surface (x).

Each of the marks 4 is a letter, a symbol, a figure, and the like for representing the manufacturer name, brand name, size, and the like of the tyre, and in this embodiment, a case is shown in which a brand name consisting of a plurality of the marks 4 is formed on the reference surface (x).

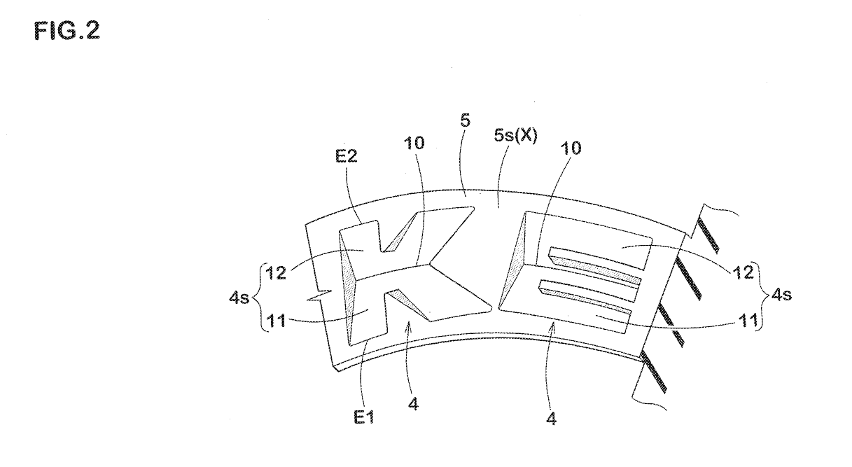

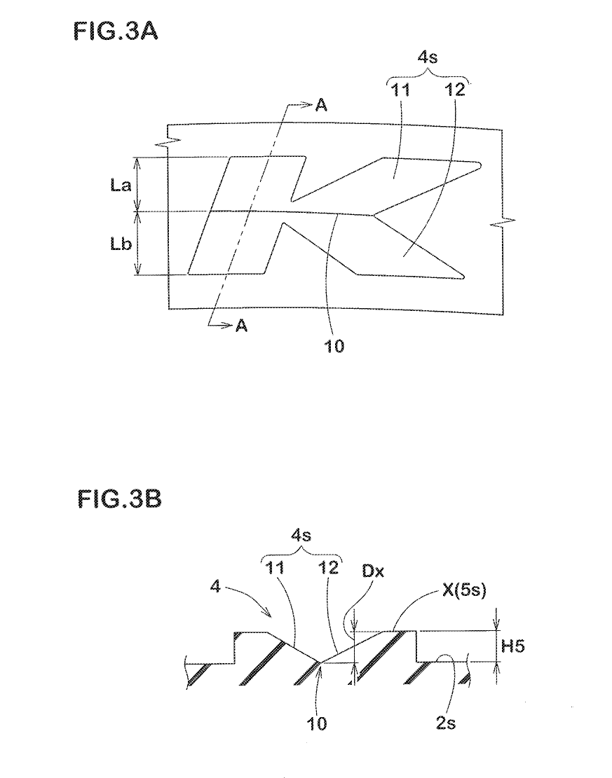

As shown in FIGS. 2, 3A, and 3B, each of the marks 4 is formed in a concave shape recessed from the reference surface (x). A surface (4s) (bottom surface) of each of the marks 4 is divided into a first surface portion 11 and a second surface portion 12 by a section line 10 crossing the surface (4s).

The section line 10 in this embodiment has a constant depth (Dx) from the reference surface (x), It is preferred that the depth (Dx) is equal to or less than the height (H5) of the base portion 5 from the surface (2s) of a respective one of the sidewall portions 2 from the point of view of securing strength of the sidewall portions 2. Note that the depth (Dx) may vary in a length direction of the section line 10. In this case, it is preferred that the section line 10 is formed in an arcuate shape in which the depth (Dx) is decreased gradually and smoothly from a center in the length direction toward both ends thereof.

The section line 10 in this embodiment extends in a tyre circumferential direction. Specifically, the section line 10 is curved so as to extend in an arc shape centered on an axis of the tyre. In particular, it is preferred that the section lines 10 of a plurality of the marks 4 which is arranged within one mark indicating portion 3 are positioned on one circumferential line around the axis of the tyre.

As shown in FIG. 3A, in a case where the section line 10 extends in the tyre circumferential direction, in a front view, it is preferred that a distance (La) in a tyre radial direction between an outermost end in the tyre radial direction of each of the marks 4 and the section line 10 thereof is in a range of from 0.8 to 1.2 times a distance (Lb) in the tyre radial direction between an innermost end in the tyre radial direction of each of the marks 4 and the section line 10 thereof. If it is out of this range, the balance between the first surface portion 11 and the second surface portion 12 is deteriorated, therefore, design property is deteriorated.

Each of the first surface portion 11 and the second surface portion 12 is inclined in a direction in which a depth thereof from the reference surface (x) is decreased as it goes away from the section line 10.

When the section line 10 extends in the tyre circumferential direction, the first surface portion 11 and the second surface portion 12 are inclined in opposite directions to each other (upward and downward) with respect to the tyre radial direction. Thereby, irrespective of the positions on the surfaces (2s) of the sidewall portions 2 at which the marks 4 are arranged, the surfaces (4s) of the marks 4 reflect light, therefore, it is possible that the legibility is increased. Moreover, each of the surfaces (4s) is inclined in a v-shape, therefore, a change is given to the appearance of the marks 4, thereby, the stereoscopic effect is increased. Therefore, it is possible that the design property and the legibility are improved.

Each of the first surface portion 11 and the second surface portion 12 can be formed as a flat surface. However, it can also be formed as a curved surface curved in a concave shape or a convex shape, for example.

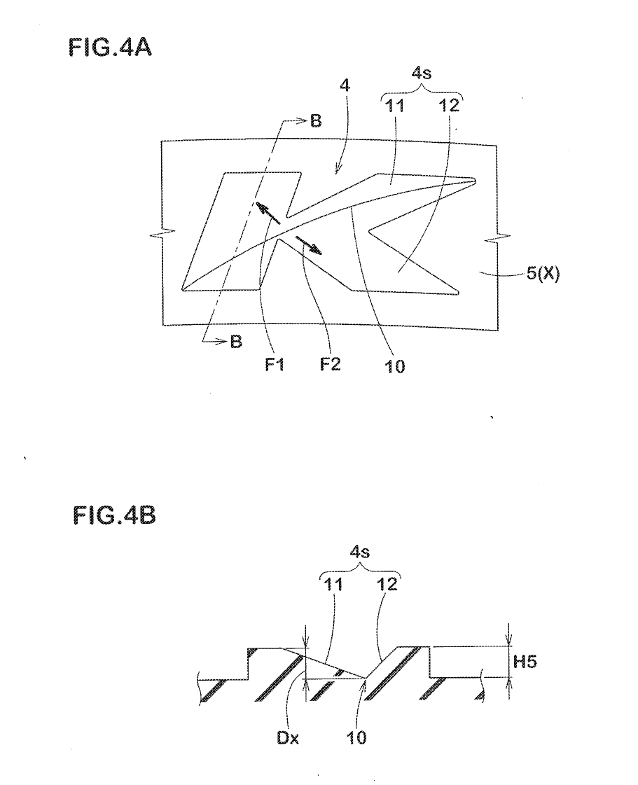

FIG. 4A is a front view of one of the marks 4 in another embodiment and FIG. 4B is a cross-sectional view thereof taken along B-B line. In this example, when the one of the marks 4 is viewed from the front, the section line 10 extends diagonally on the surface (4s) of the one of the marks 4.

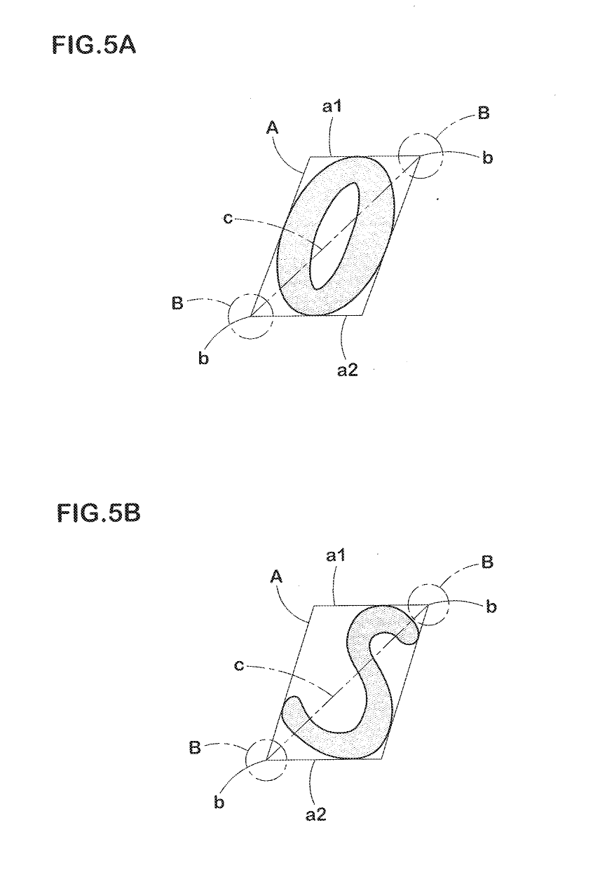

Here, “extending diagonally” is defined as follows. As shown in FIGS. 5A and 58, when the smallest parallelogram among parallelograms (including the rectangles) surrounding one of the marks 4 is defined as a parallelogram (A), extending diagonally means extending in a direction so as to connect between diagonal neighborhoods (B) of the parallelogram (A), Here, the parallelogram (A) includes an upper side (a1) and a lower side (a2) extending in the tyre circumferential direction. Further, each of the diagonal neighborhoods (B) means a range in which a distance from a respective one of diagonals (b) of the parallelogram (A) is 10% or less of a length of a diagonal line (c). It is preferred that the section line 10 extends in a direction so as to connect between the diagonals (b). As shown in FIG. 4A, the section line 10 in this embodiment is formed in an arcuate curved line in a front view of each of the marks 4. However, it can also be formed in a straight line.

In a case where the section line 10 is inclined toward upper right as in this embodiment (FIG. 4A), the first surface portion 11 is inclined toward an upper left direction F1 and the second surface portion 12 is inclined toward a lower right direction F2. In other words, the first surface portion 11 and the second surface portion 12 are inclined with respect to both the tyre circumferential direction and the tyre radial direction.

Therefore, irrespective of the positions on the surfaces (2s) of the sidewall portions 2 at which the marks 4 are arranged, the surfaces (4s) of the marks 4 reflect light, therefore, it is possible that the legibility is increased. Further, the first surface portion 11 and the second surface portion 12 have components that are inclined in opposite directions to each other with respect to the tyre circumferential direction, therefore, the reflecting surfaces appear changing and sparkling when the tyre rotates. Thereby, it is possible that the visibility is further improved as compared with the case where the section line 10 extends in the tyre circumferential direction.

Although not shown, in a cross section taken orthogonal to the section line 10, it is preferred that an inclination angle of the first surface portion 11 with respect to the reference surface (x) is the same as an inclination angle of the second surface portion 12 with respect to the reference surface (x) from a point of view of the design property. Further, from the point of view of the design property, it is preferred that a ratio (J1/J2) between an area (J1) of the first surface portion 11 and an area (J2) of the second surface portion 12 is in a range of from 0.7 to 1.3 when the surface (4s) is viewed from the front.

In each of the mark indicating portions 3, it is possible that the marks 4 are directly formed on the surface (2s) of a respective one of the sidewall portion 2 without having the base portion 5 formed thereon. In this case, the surface (2s) of the sidewall portion 2 forms the reference surface (x). In this case, in order to distinguish the mark indicating portions 3 from other portions, it is preferred that the surface (2s) of each of the sidewall portions 2 is provided with a rib and the like having a small height and surrounding a respective one of the mark indicating portions 3.

While detailed description has been made of the tyre as especially preferred embodiments of the present invention, the present invention can be embodied in various forms without being limited to the illustrated embodiments.

### WORKING EXAMPLES (EXAMPLES)

Tyres provided with the mark indicating portions on the surface of the sidewall portions were made by way of test according to the specifications listed in Table 1, and then the legibility of the marks was compared.

In Reference 1, no section line is provided and the surface (bottom surface) of each of the marks is formed as a flat surface.

In Example 1, the section line extends in the tyre circumferential direction, therefore, the first surface portion and the second surface portion are inclined in the tyre radial direction in a v-shape. Further, in Example 2, in each of the marks, the section line extends diagonally, therefore, the first surface portion is inclined in the direction F1 and the second surface portion is inclined in the direction F2 (shown in FIG. 4A) so as to form a v-shape. Note that a depth of each of the marks of the Reference 1 and each of the depths (Dx) of the section lines in the Examples 1 and 2 are equal to the height (H5) of each of the base portions. Further, in a plan view, each of the section lines is formed in an arcuate curved line. Furthermore, in each of the marks, the first surface portion and the second surface portion which are divided by the section line are each formed as a flat surface.

The legibility was evaluated by a visual observation and the evaluation is indicated by an index based on the Reference 1 being 100, wherein a larger numerical value is better.

TABLE 1

| <Mark indicating portion> | Ref. 1 | Ex. 1 | Ex. 2 |
|---|---|---|---|
| Base portion | Present | | |
| Mark | Present (concave) | | |
| Presence or Absence | Absence | Presence | |
| of Section line | | | |
| Direction of Section line | — | Tyre circumferential direction | diagonal direction |
| Inclination of Surface | Not inclined | Inclined (v-shape) | |
| Legibility | 100 | 110 | 115 |

As shown in Table 1, it was confirmed that the tyres as the Examples showed excellent legibility of the marks.

1. A tyre comprising a sidewall portion provided with a mark indicating portion having one or more marks, wherein
the mark indicating portion comprises a reference surface provided on a surface of the sidewall portion and the one or more marks formed on the reference surface in a concave manner,
a surface of the or each mark is divided into a first surface portion and a second surface portion by a section line crossing the surface of the or each mark, and
each of the first surface portion and the second surface portion is inclined in a direction in which a depth thereof from the reference surface is decreased as it goes away from the section line.

2. The tyre according to claim 1, wherein
the section line extends on the surface of the or each mark in a tyre circumferential direction.

3. The tyre according to claim 1, wherein
the section line extends diagonally on the surface of the or each mark.

4. The tyre according to claim 1, wherein
a depth of the section line from the reference surface is constant.

5. The tyre according to claim 1, wherein
the section line is a straight line or an arcuate curved line.

6. The tyre according to claim 1, wherein
each of the first surface portion and the second surface portion is a flat surface or a concave or convex curved surface.

7. The tyre according to claim 1, wherein
the mark indicating portion is provided with a base portion projecting from the surface of the sidewall portion at a constant height, and
a surface of the base portion forms the reference surface.

8. The tyre according to claim 7, wherein
a depth of the section line from the reference surface is equal to or less than the height of the base portion from the surface of the sidewall portion.

9. The tyre according to claim 1, wherein
a depth of the section line from the reference surface varies in a length direction of the section line.

10. The tyre according to claim 9, wherein
the depth of the section line is decreased gradually and smoothly from a center in the length direction toward both ends of the section line.

11. The tyre according to claim 2, wherein
the section line is curved so as to extend in an arc shape centered on an axis of the tyre.

12. The tyre according to claim 11, wherein
the sidewall portion is provided with a plurality of the marks, and
the section lines of the plurality of the marks are each positioned on one circumferential line around the axis of the tyre.

13. The tyre according to claim 2, wherein
in a front view, a distance in a tyre radial direction between an outermost end in the tyre radial direction of the or each mark and the section line thereof is in a range of from 0.8 to 1.2 times a distance in the tyre radial direction between an innermost end in the tyre radial direction of the or each mark and the section line thereof.

14. The tyre according to claim 1, wherein
in a cross section orthogonal to the section line, an inclination angle of the first surface portion with respect to the reference surface is the same as an inclination angle of the second surface portion with respect to the reference surface.

15. The tyre according to claim 1, wherein
a ratio (J1/J2) of an area (J1) of the first surface portion to an area (J2) of the second surface portion is in a range of from 0.7 to 1.3 when the surface of the or each mark is viewed from the front.

16. The tyre according to claim 1, wherein
the surface of the sidewall portion forms the reference surface.

17. The tyre according to claim 16, wherein
the surface of the sidewall portion is provided with a rib surrounding the mark indicating portion.
